(19) United States
(12) Patent Application Publication
(10) Pub. No.: US 2006/0153461 A1
(43) Pub. Date: Jul. 13, 2006

(54) Repetition coded compression for highly correlated image data

(76) Inventor: Arvind Thiagarajan, Chennai (IN)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 10/511,235

(22) PCT Filed: Mar. 7, 2003
(86) PCT No.: PCT/IN03/00049

§ 371 Date: Feb. 16, 2006

(30) Foreign Application Priority Data
Apr. 1, 2002 (IN) 895/MAS/2001

(51) Int. Cl. G06K 9/36

(52) U.S. Cl. 382/232

(57) ABSTRACT

This invention is related to both a process and a system for compressing highly correlated image data. The system for compressing image and other highly correlated data comprises means for capturing the image, means for converting to digital form, means for reshaping the data, means for encoding the repetitions, means for storing the compressed data and means for retrieving the data. The method for compressing image and other highly correlated data comprises of steps like capturing the image, converting into digital form, reshaping the data into matrix form, encoding the repetitions into a bit-plane index and stored data values, storing the compressed data in storage memory and retrieving the data for decompression. The system and method for compressing image and other highly correlated data is described in the description and illustrated by the way of drawings.

### FIELD OF INVENTION

The present invention relates to a method and system of compressing image data and other highly correlated data streams.

### BACKGROUND OF INVENTION

Image and data compression is of vital importance and has great significance in many practical applications. And to choose between Lossy compression and Lossless compression depends primarily on the application.

Some applications, where an automatic analysis is done on the image or data, using algorithms, require a perfectly lossless compression scheme so as to achieve zero errors in the automated analysis.

Generally Huffman coding and other Source coding techniques are used to achieve lossless compression of image data.

In certain other applications, the human eye visually analyzes images. Since the human eye is insensitive to certain patterns in the images, such patterns are discarded from the original images so as to yield good compression of data. These schemes are termed as ‘Visually Lossless’ compression schemes. This is not a perfectly reversible process. In other words, the de-compressed image data is different from the original image data. The degree of difference depends on the quality of compression and also the compression ratio.

Compression schemes based on Discrete Cosine Transforms and Wavelet Transforms followed by Lossy Quantization of data are typical examples of visually lossless scheme.

As a general rule, it is desirable to achieve the maximum compression ratio with zero or minimum possible loss in the quality of the image. At the same time, the complexity involved in the system and the power consumed by the image compression system are very critical parameters when it comes to a hardware based implementation.

Usually, the image compression is carried out in two steps. The first step is to use a pre-coding technique, which is mostly based on signal transformations; the second step would be to further compress the data values by standard source coding techniques like Huffman and Lempel-Ziv schemes. The initial pre-coding step is the most critical and important operation in the entire image compression scheme. The complexity involved with DCT and Wavelet based transformations is very high because of the huge number of multiplications involved in the operations. This is illustrated in the following equation.

$$DCT ( i , j ) = \frac{1}{\sqrt{2 N}} C ( i ) C ( j ) {\sum }_{x = 0}^{N - 1} {\sum }_{y = 0}^{N - 1} f ( x , y ) cos ⌈ \frac{( 2 x + 1 ) ⅈ π}{2 N} ⌉ cos ⌈ \frac{( 2 y + 1 ) j π}{2 N} ⌉$$

$$where C ( x ) = \frac{1}{\sqrt{2}} if x = 0 , else 1 if x > 0.$$

In addition to the huge number of multiplications involved in carrying out the above DCT equation, there also happens to be a zigzag rearrangement of the image data, which involves additional complexity. This clearly proves that the above mentioned conventional schemes for image compression are not very well suited for hardware based implementation.

So, the real requirement is a image compression system which does not involve any rigorous transforms and complex calculations. It also has to be memory efficient and power efficient. The present invention called as Repetition Coded Compression (RCC) is ideally suited for the above mentioned requirements. It is based on a single mathematical operation and requires zero multiplications for its implementations. This results in great amount of memory efficiency, power efficiency and speed in performing the compression. Because of the single mathematical operation involved for implementation of the present invention, the system is perfectly reversible and absolutely lossless. This is very important for many applications, which demand zero loss. The compression ratios are significantly higher than the existing lossless compression schemes. But if the application permits a lossy compression system, the present invention can also cater to the lossy requirements. In this case a slight modification is done to the mathematical operation so that certain amount of loss is observed in the compression and thereby resulting in much higher compression ratios. This lossy compression system would find great applications in entertainment and telecommunication systems.

### DISADVANTAGES OF CURRENT IMAGE COMPRESSION TECHNIQUES

There are various Image Compression Techniques. Familiar few are JPEG, JPEG-LS, JPEG-2000, CALIC, FRACTAL and RLE.

JPEG

JPEG compression is a trade-off between degree of compression, resultant image quality and time required for compression/decompression.

Blockiness results at high image compression ratios.

It produces poor image quality when compressing text or images containing sharp edges or lines.

Gibb's effect is the name given to this phenomenon where disturbances/ripples may be seen at the margins of objects with sharp borders.

It is not suitable for 2 bit black and white images.

It is not resolution independent. Does not provide for scalability, where the image is displayed optimally depending on the resolution of the viewing device.

JPEG-LS

It does not provide support for scalability, error resilience or any such functionality. Blockiness still exist at higher compression ratios.

JPEG-LS does not offer any particular support for error resilience, besides restart markers, and has not been designed with it in mind.

JPEG-2000

Jpeg-2000 do not provide any truly substantial improvement in compression efficiency and are significantly more complex than JPEG, with the exception of JPEG-LS for lossless compression.

Complexity involved in JPEG-2000 is more for a fewer enhancement in the compression ratio and efficiency.

CALIC

Although CALIC provides the best performances in lossless compression, it cannot be used for progressive image transmission (it implements a predictive based algorithm that can work only in lossless/nearly-lossless mode). Complexity and computational cost are high.

The results show that the choice of the “best” standard depends strongly on the application at hand.

In order to ascertain the novelty of the instant application a search was conducted using US Patent database & European Patent database. As many as 400 Patent Applications were identified under the subject matter data compression. Various patent specifications were carefully considered and the novelty of the invention was ascertained.

The following specifications namely PCT/US98/07074, EP0871294A3, EP0880100A2, WO98/50886 were cited and on perusal of the various patent specifications under the European & US database, it was concluded that the scope of the claims to the instant application & the cited specifications were different.

### SUMMARY OF INVENTION

Image data is a highly correlated one. This means that, the adjacent data values in an image are repetitive in nature. So, if it is possible to achieve some compression out of this repetitive property of the image and then apply Huffman coding or other source coding schemes, the method would be very efficient.

In this Repetition Coded Compression algorithm, each element is compared with the previous element. If both of them are equal then a value of ‘1’ is stored in a Bit-plane. Otherwise a value of ‘0’ is stored in the Bit-plane. This different value is only stored in a matrix instead of storing all the repeating values.

In one-dimensional RCC Method only one bit-plane is used to code the repetition in the horizontal direction.

But in two-dimensional RCC method, two bit-planes are used to code the repetitions in both the horizontal and the vertical directions. This is more efficient and gives a better compression ratio.

This clearly proves that the compression system is implemented without any multiplications and complex transformations. It is purely based on a mathematical comparison of adjacent image data values. The comparison is performed between adjacent image data values in both the horizontal as well as vertical directions. The bit-planes formed as a result of the above-mentioned comparison in the horizontal and vertical directions are respectively combined by a binary addition method. After this the resultant bit-plane positions are called as RCC bit-planes. The zero values in the RCC bit-plane are the only ones that are to be stored for lossless reconstruction of the original image. Such values corresponding to the same locations in the original image matrix as zeros in the RCC bit-plane are called as RCC data values. All the other image data values can be reconstructed by using the RCC data values and the horizontal, vertical bit-planes.

In case of a lossy system of implementation, the adjacent pixels are not only compared for repetition, but also for the difference value. If the difference value between adjacent pixels is lesser than a given arbitrary threshold value, then the two adjacent pixels are made as the same. This further increases the number of repetitions in the image data and therefore also increases the compression ratio after Repetition Coded Compression is applied. The value of the threshold can be varied according to the requirements of the particular application and system. The higher the threshold, the better the compression ratio and also higher loss in the quality of the reconstructed image.

### OBJECTS OF INVENTION

It is the primary object of invention to invent a novel technique by way of Repetition Coded Compression for highly correlated image data. It is another object of Invention to invent a system for Repetition Coded Compression for higher correlated image data. Another object of invention is to invent a system, which is versatile in application. Further objects of the invention will be clear from the ensuing description.

### BRIEF DESCRIPTION OF FIGURES

FIG. 1

This figure illustrates the entire image compression system based on Repetition Coded Compression on a hardware implementation.

FIG. 2

This figure is a sample image of the human brain, which is captured by magnetic resonance imaging (MRI), and this sample image would be used to demonstrate the compression achieved by Repetition Coded Compression system. It is a grayscale image.

FIG. 3

This figure zooms a small region from the sample MRI image of the human brain. This zoomed region would be used for demonstrating the compression system.

FIG. 4

This figure shows that the image is made up of lot of pixels in grayscale.

FIG. 5

This figure shows a 36-pixel region within the sample MRI image of the human brain.

FIG. 6

This figure shows the ASCII value equivalent of the image data values, which are originally used for data storage. Each value requires eight bits of data memory or in other words 1 byte of data memory. Currently the 36-pixel region requires about 288 bits or 36 bytes of data memory. It would later be demonstrated that the data could be compressed and stored with only 112 bits.

FIG. 7

This figure shows the application of Repetition Coded Compression along the Horizontal Direction in the Image Matrix. This results in the Horizontal bit-plane and also the horizontal values stored.

FIG. 8

This figure shows the application of Repetition Coded Compression along the Vertical Direction in the Image Matrix. This result in the Vertical bit-plane and also the vertical values stored.

FIG. 9

This figure shows the combination of Horizontal and Vertical bit-planes by a binary addition operation thereby resulting in only five zero values which correspond to the final values store from the original image matrix.

FIG. 10

This figure shows the total memory required for the 36-pixel region before and after applying repetition coded compression. The original memory requirement was 288 bits. After applying Repetition Coded Compression the memory required was 112 bits. This proves a great amount of compression achieved.

FIG. 11

This figure shows the application of Repetition Coded Compression to the entire image and the size is compressed to 44,000 bits from the original 188,000 bits.

FIG. 12

This figure shows the complete principle for implementation of Repetition Coded Compression.

### DETAILED DESCRIPTION OF INVENTION

Image data is a highly correlated one. This means that, the adjacent data values in an image are repetitive in nature. So, if it is possible to achieve some compression out of this repetitive property of the image and then apply Huffman coding or other source coding schemes, the method would be very efficient.

In this Repetition Coded Compression algorithm, each element is compared with the previous element. If both of them are equal then a value of ‘1’ is stored in a Bit-plane. Otherwise a value of ‘0’ is stored in the Bit-plane. This different value is only stored in a matrix instead of storing all the repeating values.

In one-dimensional RCC Method only one bit-plane is used to code the repetition in the horizontal direction.

But in two-dimensional RCC method, two bit-planes are used to code the repetitions in both the horizontal and the vertical directions. This is more efficient and gives a better compression ratio.

This clearly proves that the compression system is implemented without any multiplications and complex transformations. It is purely based on a mathematical comparison of adjacent image data values. The comparison is performed between adjacent image data values in both the horizontal as well as vertical directions. The bit-planes formed as a result of the above-mentioned comparison in the horizontal and vertical directions are respectively combined by a binary addition method. After this the resultant bit-plane positions are called as RCC bit-planes. The zero values in the RCC bit-plane are the only ones that are to be stored for lossless reconstruction of the original image. Such values corresponding to the same locations in the original image matrix as zeros in the RCC bit-plane are called as RCC data values. All the other image data values can be reconstructed by using the RCC data values and the horizontal vertical bit-planes.

In case of a lossy system of implementation, the adjacent pixels are not only compared for repetition, but also for the difference value. If the difference value between adjacent pixels is lesser than a given arbitrary threshold value, then the two adjacent pixels are made as the same. This further increases the number of repetitions in the image data and therefore also increases the compression ratio after Repetition Coded Compression is applied. The value of the threshold can be varied according to the requirements of the particular application and system. The higher the threshold, the better the compression ratio and also higher loss in the quality of the reconstructed image.

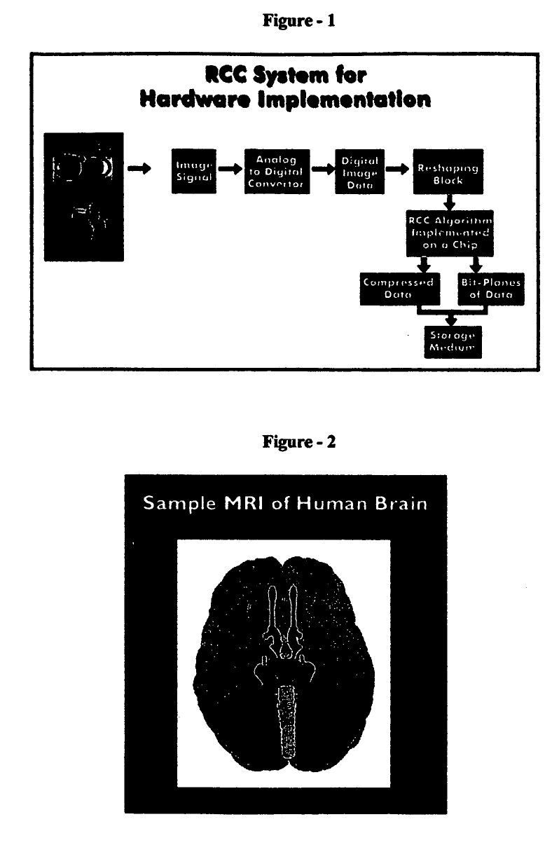

FIG. 1 illustrates the entire image compression system based on Repetition Coded Compression on a hardware implementation. The raw analog image signals are captured by the camera and are converted into respective digital data by a analog to digital converter. This digital data is arranged into a matrix of image data values by a reshaping block. The reshaped image matrix is stored in the embedded chip, which performs the entire RCC system. This therefore gives the compressed RCC data values and also the bit-planes for storage, archival and future retrieval.

FIG. 2 is a sample image of the human brain which is captured by magnetic resonance imaging (MRI) and this sample image would be used to demonstrate the compression achieved by Repetition Coded Compression system. It is a grayscale image.

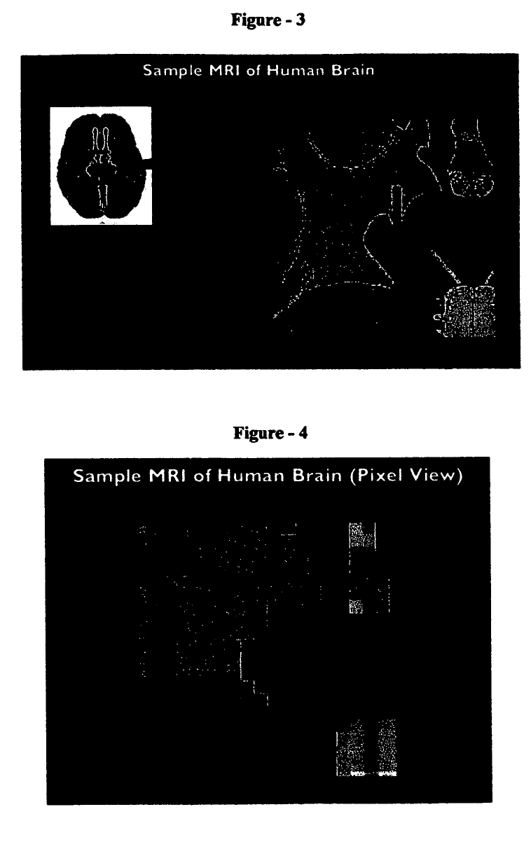

FIG. 3 zooms a small region from the sample MRI image of the human brain. This zoomed region would be used for demonstrating the compression system.

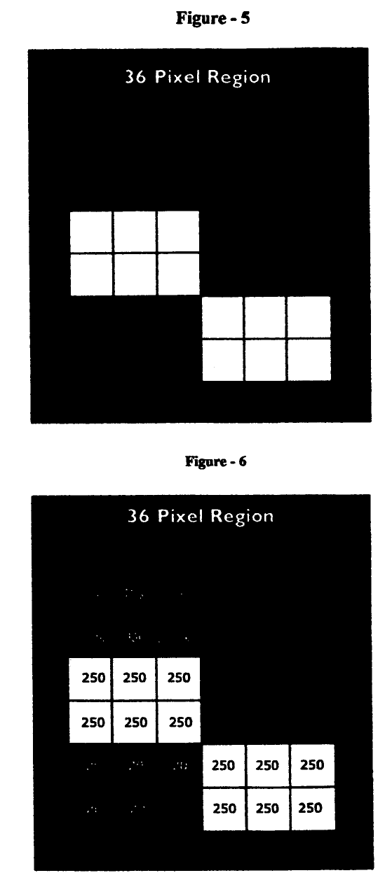

FIG. 4 shows that the image is made up of lot of pixels in grayscale. FIG. 5 shows a 36-pixel region within the sample MRI image of the human brain. FIG. 6 shows the ASCII value equivalent of the image data values which are originally used for data storage. Each value requires eight bits of data memory or in other words 1 byte of data memory. Currently the 36-pixel region requires about 288 bits or 36 bytes of data memory. It would later be demonstrated that the data could be compressed and stored with only 112 bits.

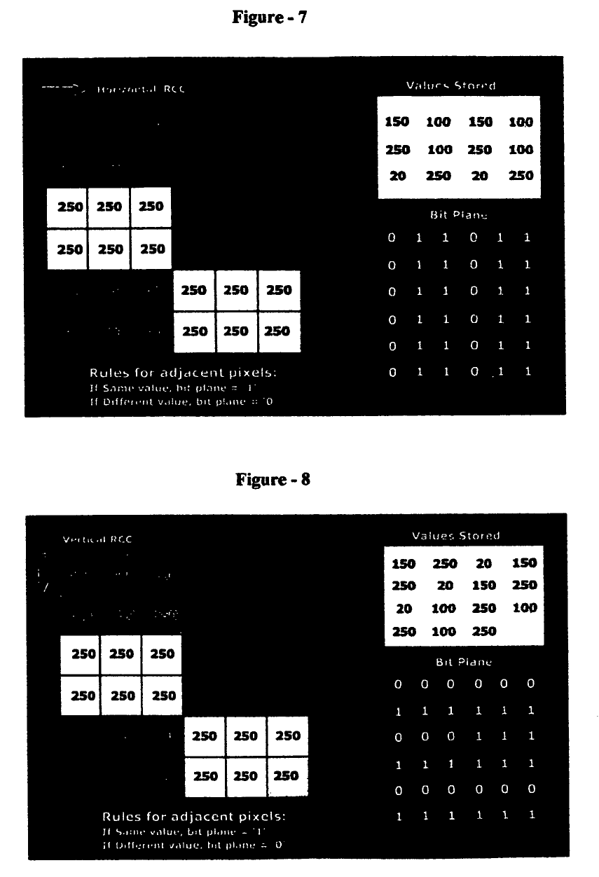

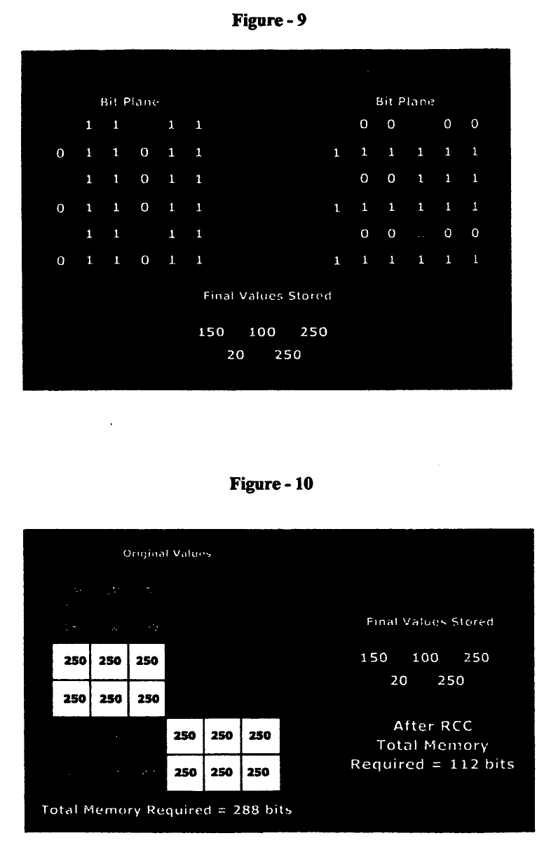

FIG. 7 shows the application of Repetition Coded Compression along the Horizontal Direction in the Image Matrix. This results in the Horizontal bit-plane and also the horizontal values stored. FIG. 8 shows the application of Repetition Coded Compression along the Vertical Direction in the Image Matrix. This result in the Vertical bit-plane and also the vertical values stored.

FIG. 9 shows the combination of Horizontal and Vertical bit-planes by a binary addition operation thereby resulting in only five zero values which correspond to the final values store from the original image matrix. FIG. 10 shows the total memory required for the 36-pixel region before and after applying repetition coded compression. The original memory requirement was 288 bits. After applying Repetition Coded Compression the memory required was 112 bits. This proves a great amount of compression achieved

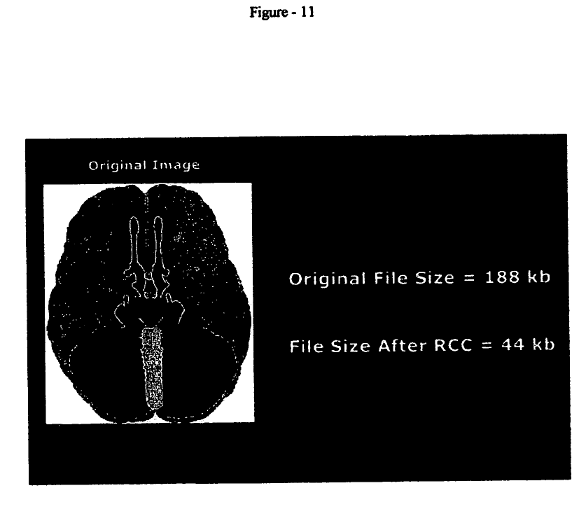

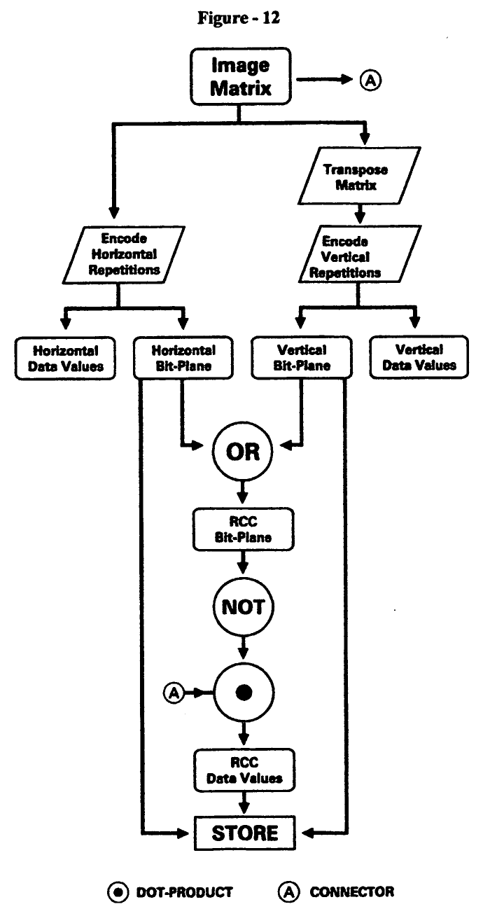

FIG. 11 shows the application of Repetition Coded Compression to the entire image and the size is compressed to 44,000 bits from the original 188,000 bits. FIG. 12 shows the complete principle for implementation of Repetition Coded Compression. The image matrix is encoded along the horizontal and vertical directions and the respective bit-planes are derived. Further compression is achieved by combining the horizontal and vertical bit-planes by a binary addition operation. This results in the RCC bit-plane, which is logically inverted and compared with the original image matrix to obtain the final RCC data values. These RCC data values along with the horizontal and Vertical bit-planes are stored in the data memory for archival and future retrieval.

The coded data can be further compressed by Huffman coding. Thus compression of the image data is achieved using Repetition Coded Compression System. This System is easy to implement and is very fast, as it does not make use of any complex transform techniques. The real advantage is that, this method can be used for any type of image file. Here the system is applied only for Grayscale images. But in future it can be applied to color images also.

In case of a lossy system of implementation, the adjacent pixels are not only compared for repetition, but also for the difference value. If the difference value between adjacent pixels is lesser than a given arbitrary threshold value, then the two adjacent pixels are made as the same. This further increases the number of repetitions in the image data and therefore also increases the compression ratio after Repetition Coded Compression is applied. The value of the threshold can be varied according to the requirements of the particular application and system. The higher the threshold, the better the compression ratio and also higher loss in the quality of the reconstructed image.

This system of Repetition Coded Compression of images can be applied to fields like Medical Image Archiving and Transmission, Database Systems, Information Technology, Entertainment, Communications & Wireless Applications, Satellite Imaging, Remote Sensing, Military Applications. The invention is described with reference to a specific embodiment and the said description will in no way limit the scope of the invention.

1. A method of compression of image data of an image wherein each element is compared with a previous element and:
(a) if they are both equal, a first value is recorded; and
(b) if they are not both equal, a second value is recorded.

2. A method as claimed in claim 1, wherein each element is a pixel.

3. A method as claimed in claim 1, wherein the first value is a 1, and the second value is a 0.

4. A method as claimed in claim 1, wherein the first and second values are stored in a bit plane.

5. A method as claimed in claim 4, wherein for a one-dimensional compression, a single bit plane is used to store the values.

6. A method as claimed in claim 4, wherein for a two-dimensional compression, comparison is in both horizontal and vertical directions, a separate bit plane being used for each direction.

7. A method as claimed in claim 6, wherein the bit-planes for the horizontal and vertical directions are combined by binary addition to form a repetition coded compression bit-plane.

8. A method as claimed in claim 7, wherein the combining is by binary addition, only the second values being stored for lossless reconstruction of the image.

9. A method as claimed in claim 8, wherein the result of the combining is repetition coded compression data values, all other image data values being able to be reconstructed using the repetition coded compression data values, and the bit planes for the horizontal and vertical directions.

10. A method as claimed in claim 4, wherein storage in bit planes is in a matrix.

11. A method as claimed in claim 1, wherein a single mathematical operation is performed for each element.

12. A system for repetition coded compression comprising:
(a) a camera for capturing at least one image and for supplying digital data;
(b) a reshaping block for rearranging the digital data into a matrix of image data values;
(c) a processor for receiving the matrix of image data values and compressing the image data values to form compressed data; and
(d) a memory for storage of the compressed data.

13. A system as claimed in claim 12, wherein the camera is analog, an analog-to-digital converter being used to convert the analog image to provide the digital data.

14. A method for compression of an image comprising:
(a) capturing the image;
(b) converting the image into digital form to provide digital data;
(c) reshaping the digital data into a digital data matrix;
(d) encoding repetitions in the digital data matrix into a bit-plane index, and stored data values; and
(e) storing the compressed data in a storage memory.

15. A method as claimed in claim 14, wherein there the bit-planes containing information regarding the repetitions along horizontal and vertical directions.

16. A method as claimed in claim 15, wherein there is further included combining the horizontal and vertical bit-planes by a binary addition operation to give a repetition coded compression bit-plane.

17. A method as claimed in claim 16, further including comparing the repetition coded compression bit-plane with the digital data matrix to obtain final repetition coded compression data values.

18. A method as claimed in claim 17, further including storing and archiving the repetition coded compression data values along with the horizontal and vertical bit-planes.

19. A method as claimed in claim 14, wherein the compression is lossless.

20. A method as claimed in claim 14, further including compression by comparison with a threshold value to achieve lossy compression and a significantly higher compression ratio.

21. (canceled)
